(19) United States
(12) Patent Application Publication
(10) Pub. No.: US 2022/0105548 A1
(43) Pub. Date: Apr. 7, 2022

(54) POWER TOOL ASSEMBLY INCLUDING A DUST COLLECTOR

(71) Applicant: MILWAUKEE ELECTRIC TOOL CORPORATION, Brookfield, WI (US)

(72) Inventor: Glenn Meyers, Greenfield, WI (US)

(21) Appl. No.: 17/429,663

(22) PCT Filed: Feb. 12, 2020
(86) PCT No.: PCT/US2020/017817

§ 371 Date: Aug. 10, 2021

Related U.S. Application Data
(60) Provisional application No. 62/806,044, filed on Feb. 15, 2019.

(51) Int. Cl. B08B 15/04; B23Q 11/00; A47L 7/00; A47L 9/02; A47L 9/28; A47L 9/14

(52) U.S. Cl. CPC B08B 15/04; B23Q 11/0046; A47L 7/0095; B28D 7/02; A47L 9/2884; A47L 9/1409; A47L 9/02

(57) ABSTRACT

A power tool assembly includes a hand-held power tool. A dust collector is coupled to and supported by the power tool. The dust collector includes a motor, a suction fan driven by the motor, and a dust container. A vacuum drill bit is also coupled to the power tool. The vacuum drill bit includes an internal passageway that is in fluid communication with the dust container of the dust collector.

### CROSS-REFERENCE TO RELATED APPLICATIONS

This application claims priority to U.S. Provisional Patent Application No. 62/806,044, filed Feb. 15, 2019, the entire contents of which are incorporated by reference herein.

### BACKGROUND

The present disclosure relates to power tools, and more particularly to dust collectors for use with power tools.

Dust collectors are typically used in tandem with hand-held drilling tools such as rotary hammers to collect dust and other debris during a drilling operation to reduce dust and other debris from accumulating at a worksite. Such dust collectors may be attached to a rotary hammer to position a suction inlet of the collector proximate a drill bit attached to the rotary hammer. Such dust collectors may also include an on-board dust container in which dust and other debris is accumulated. Such dust containers are often removable from the dust collector to facilitate disposal of the accumulated dust and debris.

Vacuum drill bits are also used with hand-held drilling tools such as rotary hammers to collect dust and other debris during a drilling operation to reduce dust and other debris from accumulating at a worksite. Such vacuum drill bits are driven by the power tool and are in fluid communication with a stand-alone vacuum in the form of either a ground-supported vacuum unit placed near the user or of a backpack-style vacuum unit carried on the back of the user.

Currently, a user has to choose either a dust collector with a shroud-type dust inlet attached to the power tool or a vacuum drill bit with a stand-alone vacuum placed on the ground or on the user's back to address dust and debris accumulation prevention.

### SUMMARY

The disclosure provides, in one aspect, a power tool assembly including a hand-held power tool. A dust collector is coupled to and supported by the power tool. The dust collector includes a motor, a suction fan driven by the motor, and a dust container. A vacuum drill bit is also coupled to the power tool. The vacuum drill bit includes an internal passageway that is in fluid communication with the dust container of the dust collector.

The disclosure provides, in another aspect, a power tool assembly including a hand-held rotary power tool, a dust collector, and a vacuum drill bit. The dust collector is suspended from the hand-held rotary power tool. The dust collector includes a suction connector, a suction pipe, and a dust collection chamber. The suction pipe is in fluid communication with the suction connector. The dust collection chamber is in fluid communication with the suction pipe. The vacuum drill bit is rotatably driven by the hand-held rotary power tool. A dust flow path extends through the vacuum drill bit, the suction connector, and the suction pipe to deposit dust in the dust collection chamber.

Other features and aspects of the invention will become apparent by consideration of the following detailed description and accompanying drawings.

### BRIEF DESCRIPTION OF THE DRAWINGS

FIG. 1 is a perspective view of a dust collector having a shroud dust inlet, the dust collector connected to a rotary power tool.

FIG. 2 is a perspective view of a vacuum drill bit and vacuum bit adapter connected to a stand-alone vacuum, the drill bit coupled to the rotary power tool of FIG. 1.

FIG. 3 is another perspective view of the vacuum drill bit, vacuum bit adapter, stand-alone vacuum, and rotary power tool of FIG. 2.

FIG. 4 is a side elevation view of the vacuum drill bit and vacuum bit adapter of FIG. 2.

FIG. 5 is a perspective view of one example end of the vacuum drill bit of FIG. 2.

FIG. 6 is a perspective view of another example end of the vacuum drill bit of FIG. 2.

FIG. 7 is a side elevation view of a power tool assembly of the present disclosure.

FIG. 8 is a schematic representation of the power tool assembly of FIG. 7.

### DETAILED DESCRIPTION

Before any embodiments of the disclosure are explained in detail, it is to be understood that the invention is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

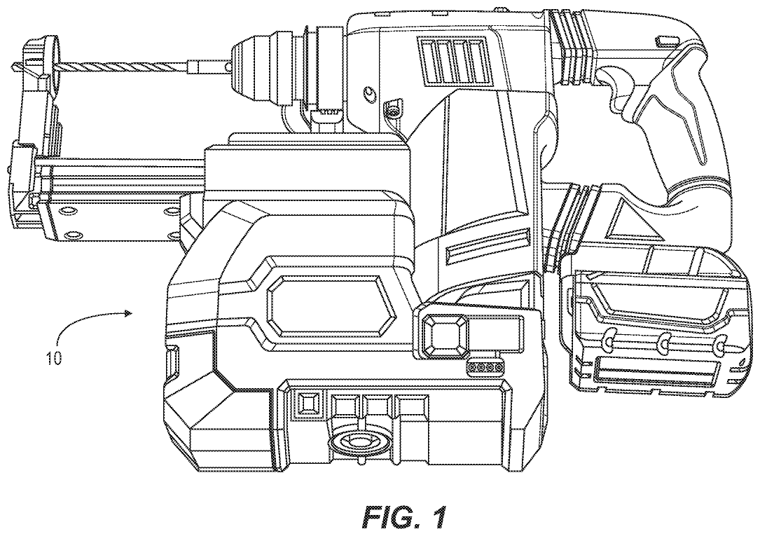

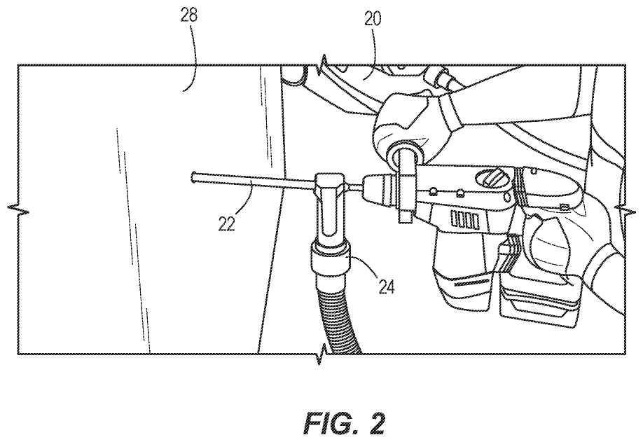

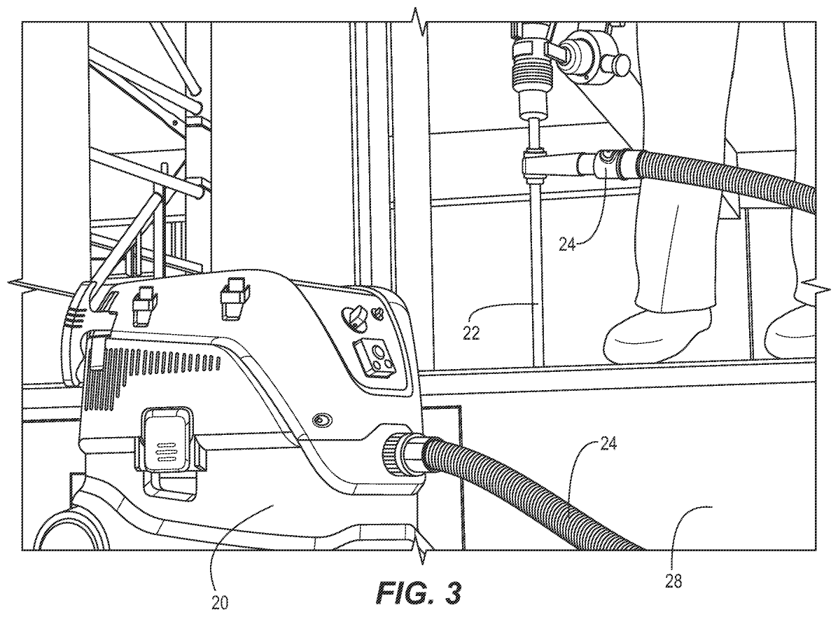

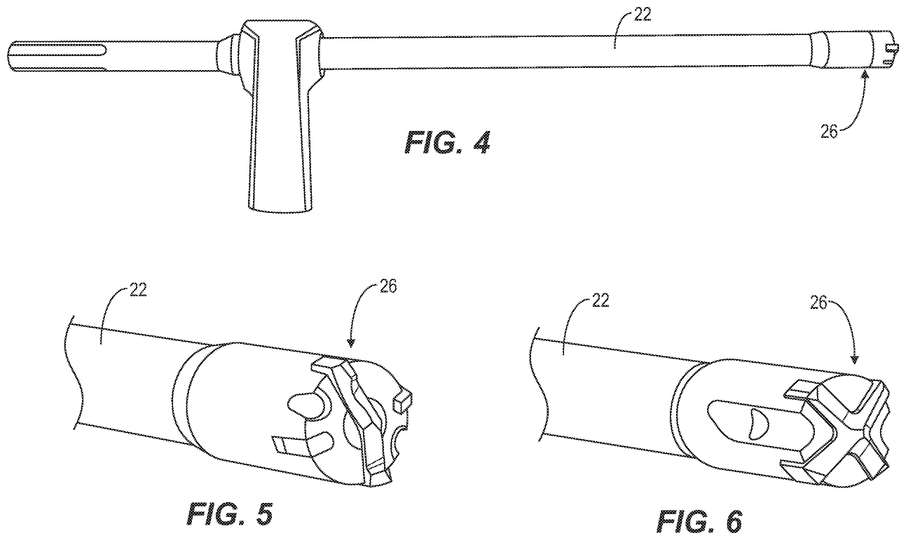

Currently, a user has to choose either a dust collector 10 that has a shroud dust inlet (shown in FIG. 1) or a stand-alone vacuum 20 connected to a vacuum drill bit 22 by a flexible vacuum hose 24 (shown in FIGS. 2-3). As shown in FIGS. 4-6, the vacuum drill bit 22 can have different heads 26 as appropriate for the particular application. In either configuration, the goal is to reduce the amount of dust exposed to the worker that is created from drilling into a medium 28. Each of the above dust collection choices has its own respective drawbacks. It would be desirable to incorporate beneficial aspects of each of the current choices into a new design for a power tool assembly including a hand-held power tool.

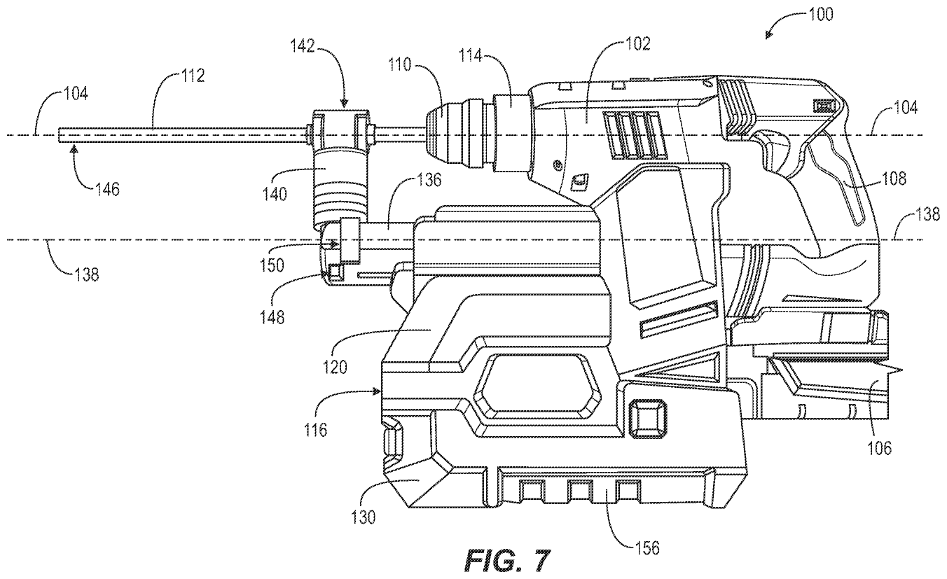

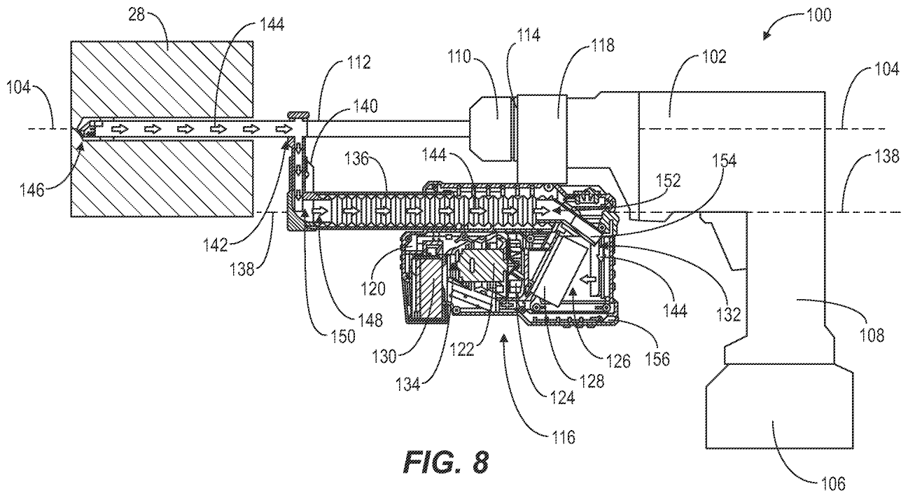

As shown in FIGS. 7 and 8, a drilling machine or rotary power tool 100, which may be configured as a percussion rotary power tool, a rotary hammer, or a hammer drill, includes a housing 102 in which a spindle (not shown) is drivable in a rotary manner about an axis of rotation 104. For this purpose, the rotary power tool 100 includes an electric motor (also not shown), which may be connected to a remote power source via a power cable. Instead of the power cable, the rotary power tool 100 may also be equipped with an on-board power source such as a rechargeable battery or a rechargeable battery pack 106. Since the rotary power tool 100 is thus operated electrically, it is an electric rotary power tool or generally a power tool or electrically powered appliance.

The rotary power tool 100 is also equipped with a handle 108. The power tool 100 may thus be operated by hand and accordingly be designated a hand-held rotary power tool 100. Accordingly, the rotary power tool 100 may generally be a hand-held power drill or a hand-held power tool or hand-held power machine tool.

The rotary power tool 100 is also equipped with a chuck 110 that is drivable in a rotary manner about axis of rotation 104 via the spindle. The chuck 110 serves to hold a tool, particularly a drilling tool, which may be a drill bit, a hammer drill bit, or a masonry drill bit. In the present embodiment, the tool includes a vacuum drill bit 112. The vacuum drill bit 112 rotates about the axis of rotation 104. Adjacent to the chuck 110, the housing 102 of the rotary power tool 100 is furnished with a clamping neck 114, which has a cylindrical shape in the illustrated embodiment. The cross section of the clamping neck 114 conforms to a standard size, for example 43 mm.

The rotary power tool 100 is equipped with a dust suction device or dust collector 116 in accordance with an embodiment of the disclosure. The dust collector 116 constitutes a separate device from the rotary power tool 100, and may be attached detachably to the rotary power tool. Accordingly, the rotary power tool 100 may or may not be equipped with dust collector 116 depending on the requirement of the application. In other embodiments, the dust collector 116 may be an integral part of the power tool 100 that is not readily removable from the power tool 100.

In the mounted state shown in FIG. 7, the dust collector 116 is arranged on the rotary power tool 100. In this state, the dust collector 116 is entirely supported by the rotary power tool 100 such that if a user carries the rotary power tool 100 by the handle 108, the user also carries the dust collector 116. With reference to the normal operating position for the rotary power tool 100, the dust collector 116 is arranged forward and below of the rotary power tool. The user may, thereby, also grasp part of the dust collector 116 to hold the rotary power tool 100 with a second hand.

In the embodiment shown in FIG. 8, the dust collector 116 includes an adapter or support frame 118 and a housing 120 that is shown in cross-section in FIG. 8 and in side elevation in FIG. 7. The support frame 118 is attached to the rotary power tool 100 about the clamping neck 114. In this embodiment, the dust collector 116 may be mounted on the clamping neck 114 in the same way as an auxiliary handle, that is to say, instead of an auxiliary handle. Of course, other appropriate attachments between the housing 120 of the dust collector 116 and the rotary power tool 100 are contemplated herein such as, for example, coupling to the housing of the rotary power tool, a battery or battery pack of the rotary power tool, and the like.

With continued reference to FIG. 8, an electric motor 122 and a suction fan 124 are disposed in the housing 120. The electric motor 122 drives the suction fan 124. The housing 120 also contains a dust collection chamber 126. The housing 120 further accommodates a dust filter 128. The housing 120 also has a power source 130 for supplying the electric motor 122 with electrical energy. The power source 130 may be in the form of a battery, but preferably a rechargeable battery or rechargeable battery pack. In other embodiments, the electric motor 122 may be powered by the battery pack 106 of the power tool 100, and the power source 130 may be omitted.

The housing 120 is also furnished with an air inlet 132 and an air outlet 134, which may have the form of a plurality of slots positioned radially adjacent to the suction fan 124. The dust filter 128 is arranged upstream of the suction fan 124 in a flow path leading from the air inlet 132 to the air outlet 134. In this way, the fan 124 is protected from being hit by dirt particles and other debris. Accordingly, the dust collection chamber 126 is also located upstream of the fan 124 and upstream of the dust filter 128.

With continued reference to FIG. 8, a suction pipe 136 is fastened to the housing 120 in such manner that the suction pipe 136 is axially adjustable relative to the housing 120. In the illustrated embodiment, the suction pipe 136 is a straight suction pipe. In other embodiments, the suction pipe 136 may be non-linear (e.g., curved or bent) and/or may be flexible. The axial direction of the suction pipe 136 is defined by its longitudinal centerline 138, which extends parallel to the axis of rotation 104 of the spindle and the vacuum drill bit 112 when the dust collector 116 is mounted to the rotary power tool 100. The longitudinal centreline 138 is offset from the axis of rotation 104 such that the suction pipe 136 itself does not contact the vacuum drill bit 112. As the suction pipe 136 is axially adjustable, it is possible to adjust the dust collector 116 to match the different lengths of various types of vacuum drill bits 112 inserted in the chuck 110. Once the position of the suction pipe 136 has been adjusted relative to the housing 120, the suction pipe 136 may be locked in position via a locking device. The locking device may include for example a clip that extends over the suction pipe 136 and a retaining screw for clamping the suction pipe to the housing 120.

With reference to FIGS. 7 and 8, a suction connector 140 is attached to the suction pipe 136 distally with respect to the housing 120. An upstream end 142 of the suction connector 140 is coupled to the vacuum drill bit 112. More particularly, the vacuum drill bit 112 passes through the upstream end 142 of the suction connector 140. As shown best in FIG. 8, a dust flow path 144 starts at one or more openings in the head 146 of the vacuum drill bit 112. The dust flow path 144 continues through the passageway of the vacuum drill bit 112, exits the vacuum drill bit 112 in a direction that is lateral or radial from the axis of rotation 104, and enters the passageway of the suction connector 140 through the upstream end 142 of the suction connector 140. An inlet end 148 of the suction pipe 136 is in fluid communication with a downstream end 150 of the suction connector 140. As such, the dust flow path 144 continues through the suction connector 140, exits the suction connector 140 through the downstream end 150, and enters the suction pipe 136 through the inlet end 148. At the output end 152 of the suction pipe 136, the dust flow path 144 exits the suction pipe 136 and enters the air inlet 132 of the dust collector 116.

With reference to FIGS. 7 and 8, the suction pipe 136 is advantageously of telescoping construction. For this purpose, the suction pipe 136 is mounted slidably relative to the housing 120 of the dust collector 116. The telescoping suction pipe 136 is able to be adjusted axially so that the dust collector 116 may be adapted to the differing lengths of available vacuum drill bits 112 with which it is used.

In order to provide a dust-tight fluid coupling between the suction pipe 136 and the housing 120 of the dust collector 116, a corrugated or expandable tube may be provided that folds together like an accordion when the suction pipe 136 advances into the housing 120, and unfolds in the manner of an accordion when the suction pipe 136 is withdrawn from the housing 120.

In other embodiments, the suction pipe 136 is rigidly connected to the housing 120 of the dust collector 116. In such embodiments, a vacuum drill bit 112 having a predetermine length (or ranges of lengths) may be used.

In order to be able to switch on the dust collector 116 manually, the dust collector 116 may be equipped with a button switch that is operable manually, for example by rotating, pressing, or sliding, and which is attached to housing 120. Actuation of the switch energizes the electric motor 122 and thus causes the fan 124 to activate.

The dust filter 128 may be designed as a fine dust filter. Such a fine dust filter, which may also be referred to as a HEPA filter (High Efficiency Particulate Absorber), is able to trap at least 99.97% of particles 0.3 microns and smaller that are typically generated during drilling. In this way, not only is the fan 124 protected from being hit by larger particles, but fine dust is also inhibited from contaminating the area surrounding the rotary power tool 100. The dust filter 128 may include a standard filter medium such as a fleece material or a paper material.

In order to inhibit the dust filter 128 from being damaged by the impact of larger particles as well, an impactor 154 (FIG. 1) may be arranged in the dust flow path 144 and upstream of the dust filter 128 in the housing 120. The impactor 154 forms a collision plate that is arranged in the flight path of the airborne particles, in the area of the air inlet 132 of the dust collector 116 and downstream of the output end 152 of the suction pipe 136. The impactor 154 causes a powerful flow diversion of the arriving suction stream, causing the suction stream initially to be directed away from the dust filter 128. The impactor 154 diverts the arriving stream into the dust collection chamber 126. Once there, the stream is then redirected again so that the air reaches the suction side of the fan 124 through the dust filter 128. In this way, it is possible to inhibit the dust filter 128 from being bombarded directly by the particles carried along in the dust flow path 144. At the same time, the airborne particles are subjected to a powerful decelerating force, thus enabling them to accumulate more easily in the dust collection chamber 126.

The dust collection chamber 126 is defined at least partially by a collection container 156. The collection container 156 is a separate component from the housing 120 and is attached detachably to the housing. Together, the housing 120 and the collection container 156 define the dust collection chamber 126. Because the collection container 156 is detachable, the dust collection chamber 126 may be emptied very easily. Moreover, different collection containers 156 may be selected for attachment to the housing 120. For example, the comparatively small collection container 156 shown is suitable for collecting rock waste material that is created when drilling in concrete 28 or rock. However, if the rotary power tool 100 is to be used for drilling wood, a considerably larger dust collection chamber is required and a correspondingly larger collection container or collecting pouch or bag may accordingly be attached to the housing 120.

It is particularly advantageous to make the collection container 156 from a relatively hard and/or rigid plastic, which is practically designed so that the collection container is not noticeably deformed due to the vacuum generated in the dust collection chamber 126 when the dust collector 116 is being operated.

The housing 120 may also be made such that it is at least partly transparent to visible light at least in the area of the dust collection chamber 126. For example, the housing 120 may be furnished with a transparent window in the area of the dust collection chamber 126 to view the accumulated height of the dust and other debris within the chamber. If, as here, a collection container 156 is used, the container may be made to be entirely transparent for the same purpose. The collection container 156 may equally contain at least one transparent window, and the rest of the container may be non-transparent or opaque. The housing 120 is advantageously made from a plastic for this purpose. If the housing 120 and/or collection container 156 includes transparent and non-transparent areas, the housing 120 and the collection container 156 may be manufactured using different plastics.

Although the present disclosure has been described in detail with reference to certain preferred embodiments, variations and modifications exist within the scope and spirit of one or more independent aspects of the disclosure as described. Various features of the invention are set forth in the following claims.

1. A power tool assembly comprising:
a hand-held power tool;
a dust collector coupled to and supported by the hand-held power tool, the dust collector including
a motor,
a suction fan driven by the motor,
a dust container, and
a suction connector slidably adjustable relative to the motor; and
a vacuum drill bit coupled to the hand-held power tool, the vacuum drill bit including an internal passageway in fluid communication with the dust container of the dust collector.

2. The power tool assembly of claim 1, wherein the dust collector is removably coupled to the hand-held power tool.

3. The power tool assembly of claim 1, wherein the vacuum drill bit is rotatably coupled to the dust collector.

4. The power tool assembly of claim 1, further comprising a battery pack configured to power both the hand-held power tool and the motor of the dust collector.

5. The power tool assembly of claim 1, further comprising first and second power tool battery packs, each of which is interchangeably coupled with the hand-held power tool and the dust collector for separately powering the hand-held power tool and the dust collector, respectively.

6. The power tool assembly of claim 1, wherein
the dust collector further includes
a housing coupled to the hand-held power tool, and
a suction pipe coupled to the housing,
the motor is positioned in the housing,
the suction fan is operable to generate a vacuum in the suction pipe, and
the internal passageway of the vacuum drill bit is in fluid communication with the suction pipe.

7. The power tool assembly of claim 6, wherein the dust collector further includes a filter supported by at least one of the housing and the dust container, the filter being removable for servicing or replacement.

8. The power tool assembly of claim 6, wherein
the suction connector is rotatably coupled to the vacuum drill bit, and
the internal passageway of the vacuum drill bit and the suction pipe are both in fluid communication with the suction connector.

9. A power tool assembly comprising:
a hand-held rotary power tool;
a dust collector suspended from the hand-held rotary power tool, the dust collector including
a suction connector,
a suction pipe in fluid communication with the suction connector, and
a dust collection chamber in fluid communication with the suction pipe, the suction connection slidably adjustable relative to the dust collection chamber;
a vacuum drill bit rotatably driven by the hand-held rotary power tool; and
a dust flow path extending through the vacuum drill bit, the suction connector, and the suction pipe to deposit dust in the dust collection chamber.

10. The power tool assembly of claim 9, wherein the vacuum drill bit is rotatably coupled to the suction connector.

11. The power tool assembly of claim 10, wherein
the suction connector extends perpendicularly to the vacuum drill bit, and
the suction pipe extends parallel to the vacuum drill bit.

12. The power tool assembly of claim 9, further comprising a support frame coupled to both the hand-held rotary power tool and the dust collector, the dust collector suspended from the hand-held rotary power tool by the support frame.

13. The power tool assembly of claim 12, wherein the support frame is removably coupled to the hand-held rotary power tool.

14. The power tool assembly of claim 9, wherein the dust collector is removably suspended from the hand-held rotary power tool.

15. (canceled)

16. The power tool assembly of claim 9, wherein the dust collector further includes a motor and a fan driven by the motor to induce a vacuum along the dust flow path.

17. The power tool assembly of claim 16, wherein the dust collector removably receives a battery pack, the battery pack configured to provide power to the motor.

18. The power tool assembly of claim 9, wherein
the vacuum drill bit includes
a head,
an inlet opening defined in the head,
an internal passageway defined in the vacuum drill bit and extending longitudinally along the vacuum drill bit, the internal passageway in fluid communication with the inlet opening, and
a radially extending outlet opening defined in the vacuum drill bit, the radially extending outlet opening in fluid communication with the internal passageway, the suction connector includes
an upstream end rotatably coupled to the vacuum drill bit, the upstream end in fluid communication with the radially extending outlet opening of the vacuum drill bit, and
a downstream end in fluid communication with the upstream end, and the suction pipe includes
an inlet end coupled to the downstream end of the suction connector and in fluid communication therewith, and
an outlet end in fluid communication with the inlet end and with the dust collection chamber.

19. The power tool assembly of claim 18, wherein the upstream end of the suction connector is sealingly coupled to the vacuum drill bit.

20. The power tool assembly of claim 9, further comprising a filter disposed at least partially in the dust collection chamber.
